(19) United States
(12) Patent Application Publication
(10) Pub. No.: US 2005/0271242 A1
(43) Pub. Date: Dec. 8, 2005

(54) Speaker

(75) Inventor: Teruaki Kaiya, Tendo (JP)

Correspondence Address: SUGHRUE MION, PLLC, 2100 PENNSYLVANIA AVENUE, N.W., SUITE 800, WASHINGTON, DC, 20037, US

(73) Assignees: PIONEER CORPORATION; TOHOKU PIONEER CORPORATION

(21) Appl. No.: 11/123,213

(22) Filed: May 6, 2005

(30) Foreign Application Priority Data
May 7, 2004 (JP) 2004-138500
Oct. 28, 2004 (JP) 2004-313794

(51) Int. Cl. H04R 25/00

(52) U.S. Cl. 381/412

(57) ABSTRACT

The present invention is to provide a solution to reduce temperature increase of a voice coil. A vibrating portion includes a voice coil, a tubular voice coil bobbin, and a diaphragm. A magnetic circuit includes an annular top plate, an annular magnet bonded to a lower surface of the top plate and magnetized in its vertical direction, and a yoke to form an outer magnet type. The yoke includes a bottom plate and a center pole which has a magnetic gap for generation of magnetic force, to drive the diaphragm cooperating with the voice coil. The yoke has a space B inside the magnetic circuit, surrounded by the lower surface of the top plate, an inner surface of the magnet, an outer surface of the center pole, and an upper surface of the bottom plate, and has a ventilating duct to ventilate with an outside atmosphere of the magnetic circuit.

### BACKGROUND OF THE INVENTION

1. Field of the Invention

The present invention relates to a speaker utilized for several audio equipments.

2. Description of the Related Art

Electrodynamic type speakers are utilized for a conventional audio equipment. They are classified into outer magnet type and inner magnet type depending on a magnetic circuit structure, that is, a position of a magnet disposed in the magnetic circuit. In the inner magnet type, a voice coil surrounds a cylindrical magnet. Contrary to this, in the outer magnet type, a cylindrical magnet surrounds a voice coil so that the outer magnet type is slim and has a small depth and a better design than that of the inner magnet type.

An electrodynamic speaker of the outer magnet type has generally a structure as shown in FIG. 1 which is a half sectional view. A magnetic circuit 4 is arranged in the speaker and includes an annular top plate 1 having an opening 1a at the center, an annular magnet 2 magnetized in a vertical direction and bonded to a lower surface of the top plate 1, and a yoke 3 bonded to a lower surface of the magnet 2. The yoke 3 includes a bottom plate 3a and a center pole 3b upstanding from the center of the bottom plate 3a. There is formed a magnetic gap G between the center pole 3b and an inner surface of the top plate 1 in the opening 1a.

In FIG. 1, 5 is a frame bonded to an upper surface of the top plate 1, 6 is a voice coil held in the magnetic gap G and vibrates according to electric signals being supplied, 7 is a tubular voice coil bobbin which conveys a driving force generated by the voice coil 6 to a vibrating system, 8 is a diaphragm bonded to an upper end of the voice coil bobbin 7, and 9 is a damper an inner periphery of which is bonded to the upper end of the voice coil bobbin 7 similarly to the diaphragm 8 and an outer periphery of which is bonded to the frame 5. An outer periphery of the diaphragm 8 is supported by the frame 5 through an edge 10. The voice coil 6, the voice coil bobbin 7, the diaphragm 8, the damper 9, and the edge 10 form a vibrating portion 12.

In the conventional speaker, a space A surrounded by the tubular voice coil bobbin 7, in more detail, surrounded by an upper surface of the center pole 3b, an inner surface of the voice coil bobbin 7 and a lower surface of the diaphragm 8, is communicated to a space B through a narrow gap g1, wherein the narrow gap g1 is formed between an outer surface of the center pole 3b and the inner surface of the voice coil bobbin 7, and the space B inside the magnetic circuit 4 is formed by the outer surface of the center pole 3b, an upper surface of the bottom plate 3a, an inner surface of the magnet 2 and the lower surface of the top plate 1. The space A is further communicated to an outside atmosphere of the frame 5, that is, an outside space of the speaker, through a narrow gap g2 formed between the inner surface of the top plate 1 and an outer surface of the voice coil bobbin 7, and through the perforated damper 9 and a ventilating hole (not shown) disposed in an outer periphery of the frame 5.

When a large signal input is applied to the described speaker, a high current flows in the voice coil 6 so that the voice coil 6 generates heat. The heat generated at the voice coil 6 is transferred to the center pole 3b through an air sandwiched by the outer surface of the center pole 3b and the inner surface of the voice coil bobbin 7, and is transferred to the top plate 1 through an air sandwiched by the inner surface of the top plate 1a and an outer surface of the voice coil 6, for cooling respectively. The heat is further cooled by the air transfer through the gap g2. Besides low thermal conductivity of air, the ventilation between the space A and the outside atmosphere of the speaker is made through the narrow gap g1 so that the ventilation is not made enough to cool the voice coil 6. As a result, the resistance of the voice coil 6 increases due to the heat and the current therein decreases so that sound pressures corresponding to electric input are not attained.

In order to increase a heat dissipation of the air transferred to the center pole 3b from the voice coil 6, and attain a high input resistance by reducing the temperature increase of the voice coil 6, a through-hole C to communicate with the space A and the outside atmosphere of the magnetic circuit is arranged in the center of the center pole 3b, which extends from the upper surface of the center pole 3b to a bottom thereof. A perforated lid 13 is disposed in the through-hole C to prevent dust from entering into the magnetic gap G through the space A. Refer to JP,2002-262387,A.

In another case, see JP,H08-140192,A, a ventilating duct between a first space, surrounded by a lower surface of a diaphragm, an outer surface and an upper surface of a center pole, and a second space, surrounded by a lower surface of a damper, an outer surface of a voice coil, an inner surface of a frame and an upper surface of an upper plate, is arranged through a first ventilating hole and a second ventilating hole. The first ventilating hole and the second ventilating hole are formed inside and outside a voice coil bobbin respectively, by cutting out the outer surface of the center pole and an inner surface of the upper plate, respectively.

The invention of JP,2002-262387,A controls the temperature increase of the speaker by forming the through-hole C in the center pole. The heat generated at the voice coil 6 is cooled indirectly by the center pole 3b through the low thermal conductivity air of the magnetic gap so that there is a limit to control the temperature increase of the voice coil.

In the outer magnet type, the space B communicates only with the space A through the narrow gap g1 and the outside atmosphere of the frame 5 through the narrow gap g2 and the ventilating hole (not shown). Therefore, the air with increased temperature due to the heat generated at the voice coil 6 inside the space B flows through the gaps to a limited extent and stays almost there. Since the heat dissipation of the space B is only made by heat conduction, it is difficult to control the temperature inside the space B by the air flow. Then the voice coil 6 is always exposed to the relatively high temperature air of the space B and it is difficult to control the temperature of the voice coil 6.

The invention of JP,H08-140192,A forms the ventilating holes to ventilate air in the magnetic gap in which the voice coil moves. According to an upward or downward movement of the voice coil, an air flows from the damper through the second space, the second ventilating hole, the first ventilating hole, and to the first space, or flows in the reverse path to cool the voice coil. The cooling efficiency depends on the flow of the air due to the movement of the voice coil so that the ventilating ducts are not simply made larger.

### SUMMARY OF THE INVENTION

The present invention is to provide a solution to reduce temperature increase of a voice coil.

A speaker according to the present invention as claimed in claim 1, includes a voice coil, a tubular voice coil bobbin supporting the voice coil, a vibrating portion having a diaphragm attached to the voice coil bobbin, an annular top plate having an opening at the center, an annular magnet bonded to a lower surface of the top plate and magnetized in a vertical direction, and a yoke bonded to a lower surface of the magnet to form an outer magnet type. The yoke includes a bottom plate, and a center pole upstanding from an upper surface at its center. A magnetic gap for generation of magnetic force to drive the diaphragm cooperating with the voice coil is formed between an inner surface of the top plate and an outer surface of the center pole. The yoke has a ventilating duct to ventilate between a space inside a magnetic circuit, surrounded by the lower surface of the top plate, an inner surface of the magnet, the outer surface of the center pole and the upper surface of the bottom plate, and an outside atmosphere of the magnetic circuit.

### BRIEF DESCRIPTION OF THE DRAWINGS

FIG. 1 is a half sectional view of a conventional speaker;

FIG. 2A is a half sectional view of a speaker of an embodiment of the present invention;

FIG. 2B is a plan view of an upper surface of a center pole in FIG. 2A;

FIG. 2C is a sectional view of the center pole taken along a sectional line c-c in FIG. 2A;

FIG. 3A is a half sectional view of a speaker of another embodiment of the present invention;

FIG. 3B is a plan view of an upper surface of a center pole in FIG. 3A;

FIG. 4A is a half sectional view of a speaker of another embodiment of the present invention;

FIG. 4B is a plan view of an upper surface of a center pole in FIG. 4A;

FIG. 5A is a half sectional view of a speaker of another embodiment of the present invention;

FIG. 5B is a plan view of an upper surface of a center pole in FIG. 5A;

FIG. 6A is a half sectional view of a speaker of another embodiment of the present invention;

FIG. 6B is a sectional view of a center pole taken along a sectional line b-b in FIG. 6A; and

FIG. 6C is a sectional view of the center pole taken along a sectional line c-c in FIG. 6A.

### DETAILED DESCRIPTION OF THE PREFERRED EMBODIMENTS

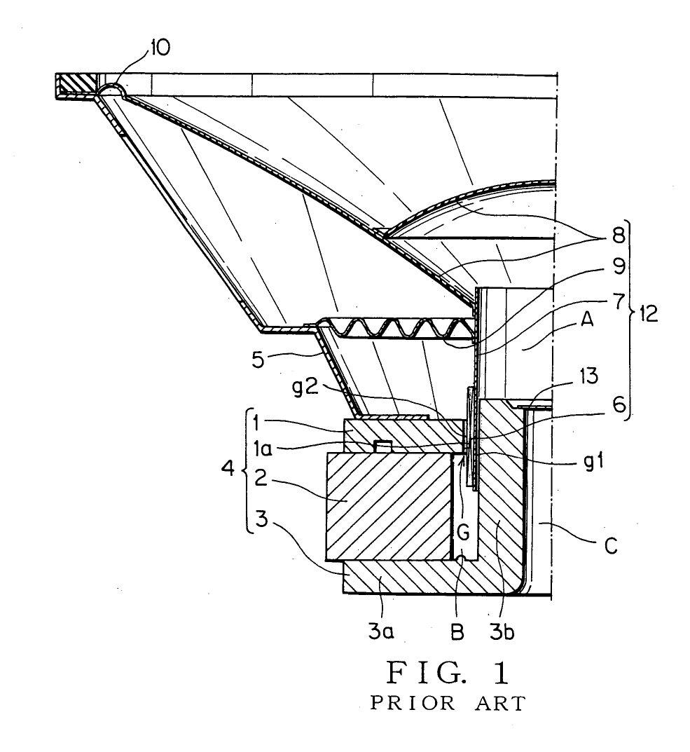

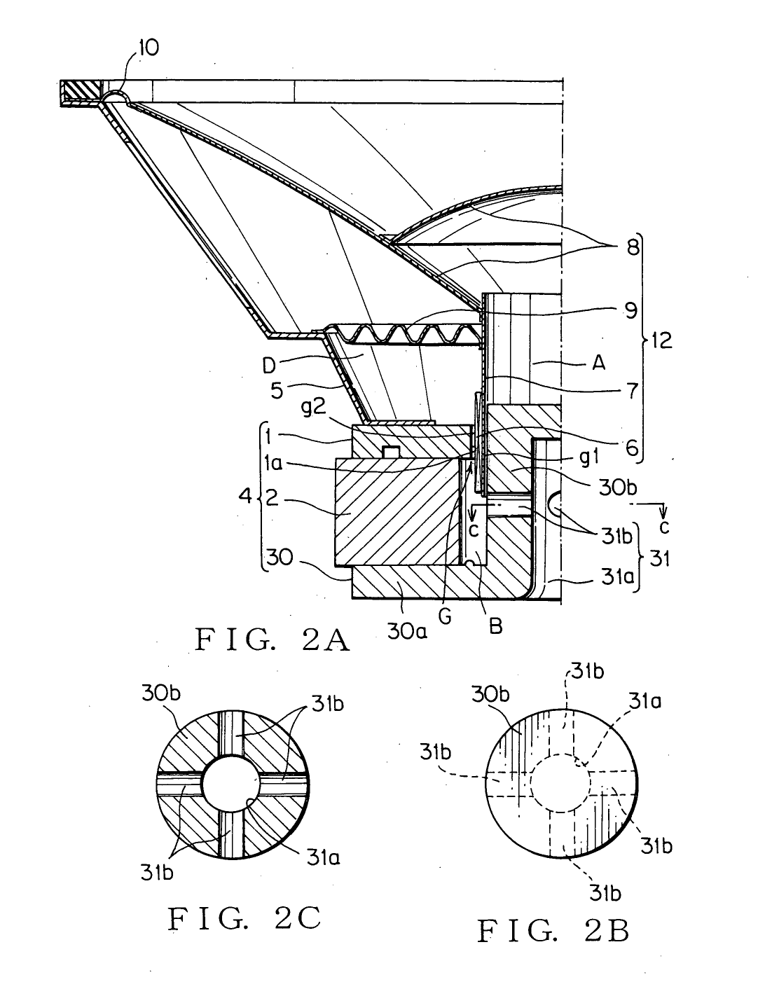

Embodiments of speakers of the present invention are illustrated in FIGS. 2 to 5 by using the same numerals for the same parts as in FIG. 1.

FIG. 2A is an embodiment of a speaker and is a half sectional view of the speaker and FIG. 2B is a plan view of an upper surface of a center pole in FIG. 2A.

In FIG. 2A, the speaker includes a vibrating portion 12 and a magnetic circuit 4 of an outer magnet type. The vibrating portion 12 is generally same as the speaker of FIG. 1 and includes a voice coil 6, a tubular voice coil bobbin 7 supporting the voice coil 6, and a diaphragm 8 attached to the voice coil bobbin 7. The magnetic circuit 4 includes an annular top plate 1 having an opening 1a at the center, an annular magnet 2 bonded to a lower surface of the top plate 1, magnetized to a vertical direction thereof, and a yoke 30 bonded to a lower surface of the magnet 2 so as to form an outer magnet type. The yoke 30 includes a bottom plate 30a and the center pole 30b upstanding from the center of an upper surface of the bottom plate 30a. A magnetic gap G to generate a magnetic force cooperating with the voice coil 6 for driving the diaphragm 8 is formed between an inner surface of the opening 1a of the top plate 1 and the center pole 30b.

The yoke 30 includes a ventilating duct 31 to ventilate between a space B inside the magnetic circuit 4 and an outside atmosphere of the magnetic circuit 4, wherein the space B is surrounded by the lower surface of the top plate 1, an inner surface of the magnet 2, an outer surface of the center pole 30b and the upper surface of the bottom plate 30a.

In the speaker as shown in FIG. 2A, a frame 5 is bonded to an upper surface of the top plate 1 and the voice coil 6 is held in the magnetic gap G and moves according with electric signal. The tubular voice coil bobbin 7 is wound by the voice coil 6 in layers and conveys a driving force generated at the voice coil 6 to a vibrating system. The diaphragm 8 is bonded to an upper end of the voice coil bobbin 7 and its outer periphery is bonded to a roll shape edge 10 of an outer periphery of the frame 5. An outer periphery of a damper 9 is bonded to the frame 5 and an inner periphery thereof is bonded to the upper end of the voice coil bobbin 7, similarly to the diaphragm 8. The diaphragm 8 is supported by the edge 10 and the damper 9, and the vibrating portion 12 includes the diaphragm 8, the voice coil 6, the voice coil bobbin 7, the damper 9 and the edge 10.

With this assembly, the voice coil 6 in the magnetic gap G moves according with the electric signal and the voice coil bobbin 7 supporting the voice coil 6 conveys the driving force generated by the voice coil 6 to the vibrating system so that the diaphragm 8 vibrates and generates sound corresponding to the electric signal. When the voice coil 6 and voice coil bobbin 7 move by an amount of the amplitude, a volume of the space B inside the magnetic circuit 4 increases or decreases according to the amount of the volume portion thereof. Thereby, a cool air enters from the outside atmosphere of the magnetic circuit 4 into the space B or an air with elevated temperature is discharged from the space B inside the magnetic circuit B to the outside atmosphere of the magnetic circuit 4, through the ventilating duct 31.

Thereby, the air with elevated temperature inside the space B is exchanged with the cool air of the outside atmosphere of the magnetic circuit 4 so that the air with elevated temperature inside the space B is not stayed and thus its temperature is controlled. The voice coil 6 and voice coil bobbin 7 move inside the magnetic gap G, and cause the air in the space B to flow through the magnetic gap G. As a result, the voice coil 6 is always exposed to the air with controlled temperature and is prevented from the temperature increase.

In this embodiment, the ventilating duct 31 includes a cylindrical hole 31a formed at the center of the center pole 30b and having an opening at a lower surface thereof, and a plurality of communicating holes 31b (four communicating holes in the embodiment of FIG. 2B) each having openings at the outer surface of the center pole 30b and an inner surface of the cylindrical hole 31a, respectively, being located midway in the vertical direction of the center pole 30b and communicating the space B inside the magnetic circuit 4 with the cylindrical hole 31a. Contrary to this, communicating holes may be formed in the bottom plate 30a of the yoke 30 extending to the space B directly without the cylindrical hole 31a. As shown in FIG. 2, when the cylindrical hole 31a and the plurality of the communicating holes 31b are formed, a surface area of the center pole 30b increases so that a heat generated at the voice coil 6 and transferred to the center pole 30b through the air, is effectively dissipated from the center pole 30b, and the air flow in a proximity of the voice coil 6 controls the temperature of the voice coil 6.

When the speaker is not operated and the diaphragm 8 is in resting state, it is possible to arrange the voice coil bobbin 7 not to cover the plurality of the communicating holes 31b. However, when the voice coil bobbin 7 moves together with the voice coil 6 inside the magnetic gap G at the operation of the speaker and the diaphragm 8 moves to a rearward direction, the communicating holes 31b in the outer surface of the center pole 30b are covered temporarily by the voice coil bobbin 7. For this reason, the communicating holes 31b may be arranged adjacent to a joint portion of the bottom plate 30a and the center pole 30b to avoid that the voice coil bobbin 7 covers the communicating holes 31b when the diaphragm 8 moves to the rearward direction. In this case, the ventilation becomes better but the communicating holes 31b are positioned apart from the voice coil 6. Since a magnetic resistance at the joint portion of the bottom plate 30a and the center pole 30b is generally high, when the communicating holes 31b are formed in the proximity of the joint portion and the magnetic resistance increases therein, a magnetic leakage occurs so that a magnetic efficiency of the magnet decreases. Then it is preferable to arrange the plurality of the communicating holes 31b in the midway of the vertical direction of the center pole 30b. In this case, at the rearward movement of the diaphragm 8, the voice coil bobbin 7 does not cover the communicating holes 31b and ensures a large enough ventilation.

In the embodiment, a space A, surrounded by a lower surface of the diaphragm 8, an inner surface of the voice coil bobbin 7 and the upper surface of the center pole 30b, is only communicated with the space B through a narrow gap g1 surrounded by the inner surface of the voice coil bobbin 7 and the outer surface of the center pole 30b. The diaphragm 8 and the voice coil bobbin 7, forming the space A, have no holes so that when the diaphragm 8 vibrates and the volume of the space A changes, the air with increased or decreased volume flows in or out from the space B only through the narrow gap g1. Thereby, when the voice coil 6 is energized and the diaphragm 8 vibrates, the air inside the space B cooled by the air flowing through the ventilating duct 31, flows through the narrow gap g1 and cools directly the voice coil 6. A ventilation portion having a large ventilation resistance may be formed in the diaphragm 8 to the extent that it does not affect the ventilation of the narrow gap g1.

The space B is communicated with a space D which is surrounded by a lower surface of the damper 9, an outer surface of the voice coil 6, an inner surface of the frame 5 and the upper surface of the top plate 1, through a narrow gap g2 between the outer surface of the voice coil 6 and the inner surface of the top plate 1, similarly to the space A. Thereby, when the damper 9 vibrates in accordance with the diaphragm 8 and a volume of the space D changes, the air of increased or decreased volume flows in or out through the narrow gap g2 from the space B the air of which is cooled by the air entered from the ventilating duct 31. For this reason, it is preferable that members forming the space D may not have a large ventilation than that of the narrow gap g2, similarly to the space A. In accordance with the vibration of the diaphragm 8, the air inside the space B with the temperature controlled, flows and cools directly both inner and outer surfaces of the voice coil 6 through the narrow gaps g1 and g2 so that the temperature increase of the voice coil 6 is further controlled.

An opposed area between the inner surface of the voice coil 6 and the outer surface of the center pole 30b in the narrow gap g1 is larger than an opposed area between the inner surface of the top plate 1 and the outer surface of the voice coil 6 in the narrow gap g2. The narrow gap g1 has a larger ventilation resistance than that of the narrow gap g2 and has a small ventilation flow. For this reason, it is necessary to cool the inner surface of the voice coil 6 by increasing the flow through the narrow gap g1.

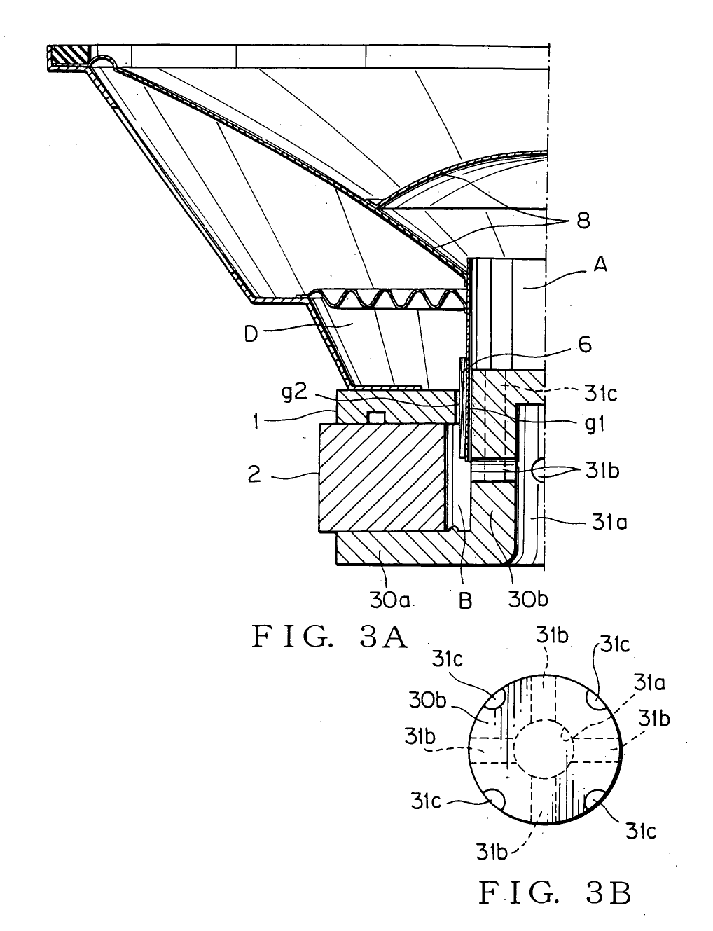

FIGS. 3A to 5A show embodiments and FIGS. 3B to 5B each are a plan view of the upper surface of the center pole 30b. In an embodiment of FIG. 3A, a plurality of grooves 31c extending from the upper end to the middle portion of the center pole 30b are formed on the outer surface thereof. Each groove 31c is located in the midway of the neighboring communicating holes 31b which are arranged 90 degrees apart with respect to the center of the center pole 30b, and in parallel with the moving direction of the voice coil 6. In this case, in order to avoid the reduction of a cross section area of the yoke more than necessarily, the grooves 31c extend from the position of the communicating holes 31b to the upper surface of the center pole 30b. With the addition of the grooves 31c, the flowing air through the narrow gap g1 increases so that the voice coil 6 is further cooled.

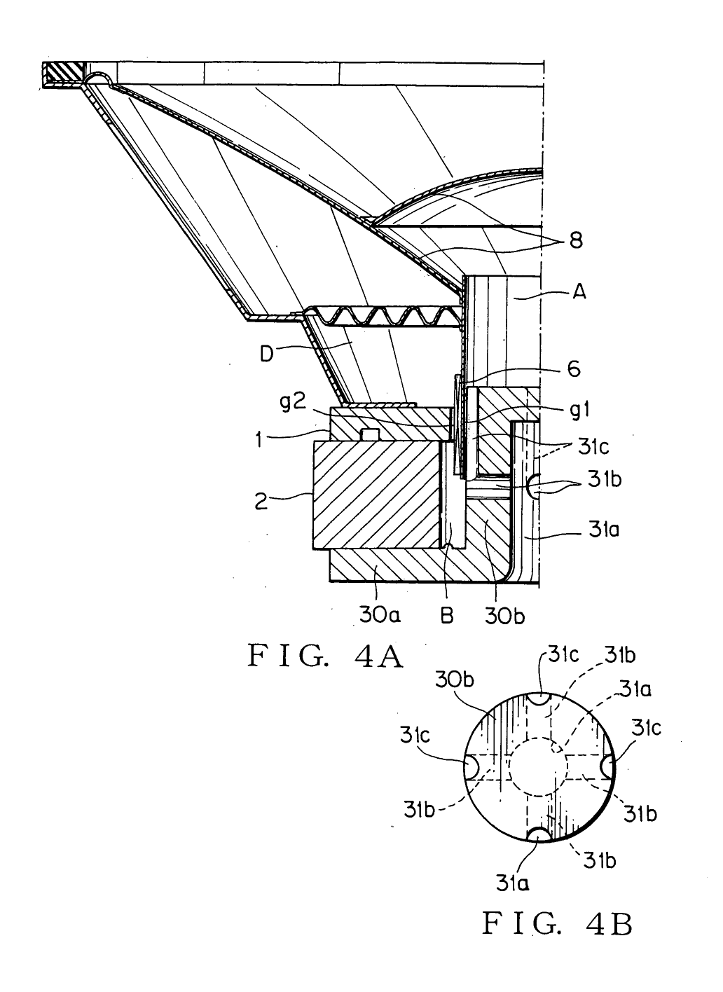

In an embodiment of FIG. 4A, a starting point of the grooves 31c formed in the outer surface of the center pole 30b corresponds with the communicating holes 31b at the outer surface of the center pole 30b. The air flows into the space B through the communicating holes 31b and flows through the grooves 31c to cool the voice coil 6 more effectively.

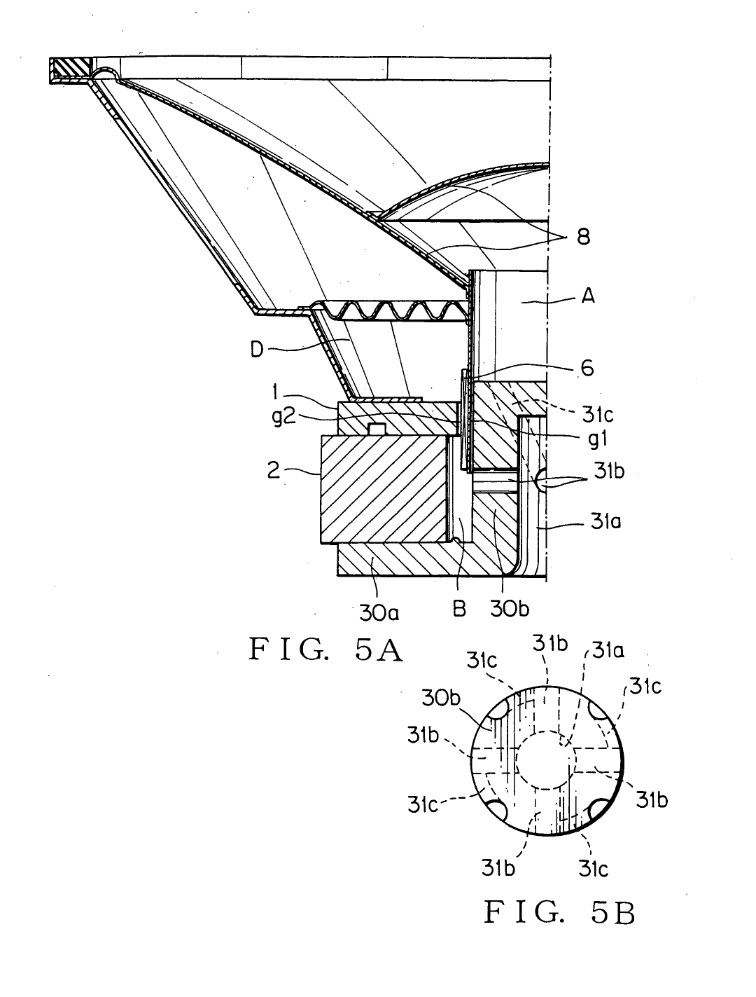

In an embodiment of FIG. 5A, each of the grooves 31c extends from the communicating hole 31b at the outer surface of the center pole 30b to the upper surface thereof and is inclined to and intersects with the moving direction of the voice coil 6. Since the inclined grooves 31c intersect with the moving direction and have a large area to contact with the air which flows through the grooves 31c of the voice coil 6, the voice coil 6 is cooled effectively and uniformly, and its temperature increase and the resulting resistance increase are reduced compared to the partial cooling.

The grooves 31c disposed in the outer surface of the center pole 30b decrease the ventilation resistance of the narrow gap g1 and prevent the generation of strain due to air compliance nonlinear in the space A.

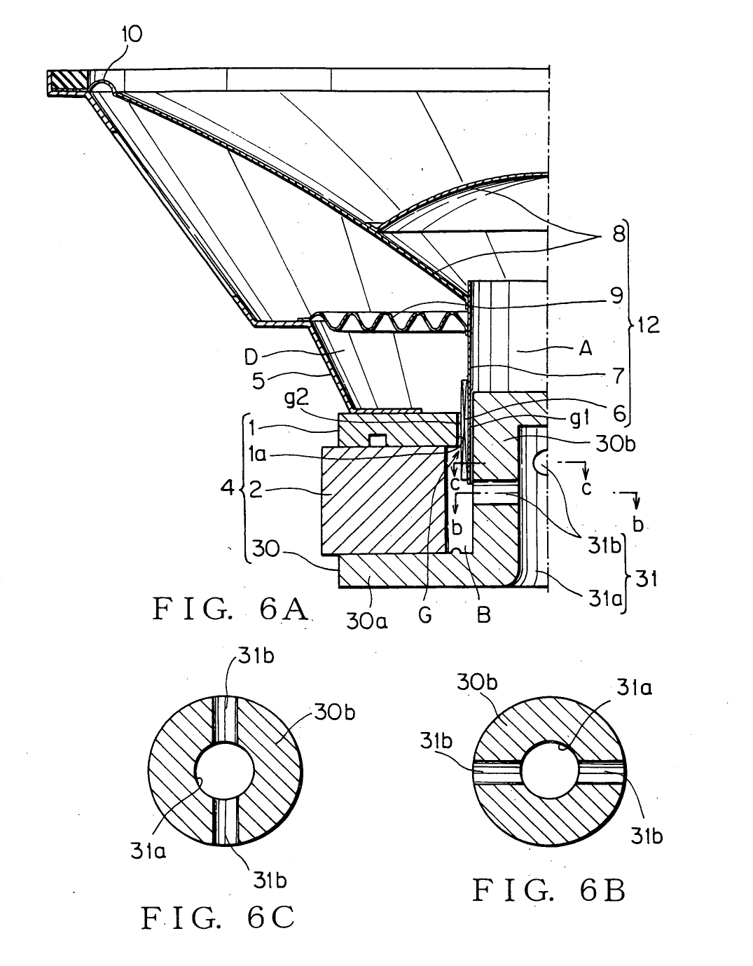

In any embodiment of FIGS. 2A to 5A, the plurality of the communicating holes 31b are formed in the middle position of the vertical direction of the center pole 30b and formed in the same height position. A cross section line c-c in FIG. 2A, that is, a cross section of the center pole 30b at the height of the communicating holes 31b, has smaller area than cross sections at the other height and has an increased magnetic resistance at this position. In general, a partially large magnetic resistance causes magnetic leakage at the part in the magnetic circuit and reduces magnetic efficiency for use. For this reason, as shown in FIG. 6A, each of four communicating holes 31b formed with equally separated 90 degrees about the center of the center pole 30b is arranged in a different height every the communicating hole 31b. Sectional views of cross section lines b-b and c-c of FIG. 6A, which are positioned at different heights, are shown in FIG. 6B and FIG. 6C, respectively. A decrease of area in each cross section of FIG. 6B and FIG. 6C is half compared to that of area in FIG. 2C. As a result, the partial increase of the magnetic resistance decreases so that the magnetic leakage is reduced and the loss of the magnetic efficiency in use is avoided. The area of the center pole 30b made of magnetic materials such as iron, shown in FIG. 6B and FIG. 6C is larger than that of FIG. 2C in which four communicating holes 31b are formed in the same cross section. The embodiments of the present invention show the four communicating holes 31b but are not limited to its number and may have an arbitrary number of communicating holes 31b.

In the embodiments having the plurality of the grooves 31c extending to the upper surface of the center pole 30b, in FIGS. 3A to 5A, when the four communicating holes 31b are arranged in the center pole 30b with the angle of 90 degrees each other and arranged in the different height every the communicating hole, the same effect as the embodiment of FIG. 6A is attained.

1. A speaker comprising:
a vibrating portion including a voice coil, a tubular voice coil bobbin supporting the voice coil, and a diaphragm bonded to the voice coil bobbin; and
a magnetic circuit of outer magnet type including an annular top plate having an opening at the center thereof, an annular magnet bonded to a lower surface of the top plate and magnetized in a vertical direction thereof, and a yoke bonded to a lower surface of the magnet,
whereby said yoke includes a bottom plate and a center pole which stands upward from an upper surface of the center of the bottom plate and forms a magnetic gap to generate a magnetic force between the center pole and an inner surface of the top plate, cooperating with the voice coil, for driving the diaphragm, and
whereby said yoke includes a ventilating duct to ventilate a space inside the magnetic circuit surrounded by the lower surface of the top plate, an inner surface of the magnet, an outer surface of the center pole and the upper surface of the bottom plate, with an outside atmosphere of the magnetic circuit.

2. The speaker as claimed in claim 1, wherein said ventilating duct has a cylindrical hole formed at the center of the center pole, opened to a lower surface of the bottom plate, and a plurality of communicating holes extending from an inner surface of the cylindrical hole to the outer surface of the center pole at a middle position in a vertical direction of the center pole.

3. The speaker as claimed in claim 2, wherein said communicating holes at the outer surface of the center pole are partly opened by the voice coil bobbin when the voice coil is in a resting position.

4. The speaker as claimed in claim 2, wherein a plurality of grooves are formed at the outer surface of the center pole and extend to an upper surface thereof.

5. The speaker as claimed in claim 4, wherein said grooves extend from the communicating holes at the outer surface of the center pole.

6. The speaker as claimed in claim 3, wherein said grooves are inclined and extend from the communicating holes at the outer surface of the center pole to the upper surface thereof with a different radial direction, intersecting with a moving direction of the voice coil.

7. The speaker as claimed in claim 2, said plurality of communicating holes are formed in a different position of the vertical direction of the center pole.

8. The speaker as claimed in claim 1, wherein a space surrounded by a lower surface of the diaphragm, an inner surface of the voice coil bobbin, and the upper surface of the center pole is communicating with the space inside the magnetic circuit surrounded by the lower surface of the top plate, the inner surface of the magnet, the outer surface of the center pole, and the upper surface of the bottom plate, only through a narrow gap between the inner surface of the voice coil bobbin and the outer surface of the center pole.
